(19) United States
(12) Patent Application Publication
(10) Pub. No.: US 2004/0193685 A1
(43) Pub. Date: Sep. 30, 2004

(54) Method and apparatus for managing and sharing personal identities in a peer-to-peer environment

(75) Inventor: Andrew Mark Proehl, San Francisco, CA (US)

Correspondence Address: MAYER, FORTKORT & WILLIAMS, PC, 251 NORTH AVENUE WEST, 2ND FLOOR, WESTFIELD, NJ, 07090, US

(73) Assignee: Sony Corporation/Sony Electronics, Inc.

(21) Appl. No.: 10/806,687

(22) Filed: Mar. 23, 2004

Related U.S. Application Data
(60) Provisional application No. 60/459,168, filed on Mar. 31, 2003.

(51) Int. Cl. G06F 15/16

(52) U.S. Cl. 709/204

(57) ABSTRACT

A method for performing a file transfer in a peer-to-peer environment enables transfers with controlled anonymity. According to this method, a file is received from a user via a third party along with a content rating from the user. Along with the file, an alias is received identifying the user. Identity information about the user is stored in the third party in association with the alias. The user can select one or more information elements within the identity information that can be sent along with the alias. Among that which can be included as the information elements are one or more of the following: an email address, a name, a mailing address, a telephone number, a social security number, a bank account number, a credit card number, an age, a birth date, income information, employment information, purchasing preference information, and an education history. Any content rating are aggregated with other content rankings from other users and identified with the alias. The third party can then act as an intermediary between the user and other users to protect the privacy of the user and to enable financial transactions to occur between the user and another user or company. One or more of these elements 51-56 can be performed together to create various useful methods for transferring files and other information between users and others.

### STATEMENT OF RELATED APPLICATION

This application claims the benefit of priority to U.S. Provisional Patent Application No. 60/459,168 filed Mar. 31, 2003 by the same inventor, entitled “Method and Apparatus For Managing And Sharing Personal Identities In A Peer-To-Peer Environment,” the entire specification of which is incorporated by reference herein.

### FIELD OF THE INVENTION

The present invention relates generally to a method for communicating information over computer networks, and more particularly to a method for communicating personal data or identity information over a computer network.

### BACKGROUND

Peer-to-peer (P2P) technology enables direct interaction between networked electronic devices, and by extension, those individuals that use them. A side effect of this interaction is that new types of community experiences are also enabled. One example of this effect allows individual content recommendations or ratings to be grouped or aggregated into an overall rating. In this way, the overall content rating is likely to be more accurate or useful than any one rating, which might otherwise include personal or subjective feelings. A good example of this in everyday life is the Zagat's restaurant reviews.

In most cases, when a group ratings system is used, only the group rating is published. Both the individual's identity and his or her rating are maintained confidential. Traditionally, there is a central organization (e.g., Zagat) that collects the individual reviews, aggregates them and publishes the results to a mass audience. Although this works adequately in most cases, it presents a problem in peer-to-peer communities.

In a peer-to-peer environment, content is passed directly from one individual to another. It is quite possible that the specific content being passed is based on some negotiation of shared interests (either explicitly or through software interaction). Although it is possible to create an anonymous data exchange, there are business and social reasons that point to a need for a system that allows exchanges between known parties. Most notably, a person referring music to another individual might receive a commission if the other purchases the music. Both individuals might also decide to build a relationship around their common interests.

Although there is clear reason to have known (i.e., non-anonymous) content exchanges between people, there are also obvious security and privacy concerns as well. Most online communities deal with this through creation of aliases. When interacting with strangers, a person creates an alias and uses that name as his or her identity when interacting with a particular individual or group. As trust is built between the various parties, a person may wish to reveal more information or even share their real identity or primary email address. However, there is no mechanism for controllably permitting this.

Because peer-to-peer technologies enable direct exchange between individuals, and as these exchanges create new opportunities for financial relationships as well as ongoing security and privacy concerns, a method is needed that will allow individual peers to create aliases that they can use in peer-to-peer negotiations. Since financial relationships can be established, a method is also needed to connect these aliases to a person's real identity.

The present invention is therefore directed to the problem of developing a method and apparatus for enabling peer-to-peer users to interact anonymously while also conducting financial transactions without revealing their actual identities or financial data.

### SUMMARY OF THE INVENTION

The present invention solves these and other problems by providing a method and apparatus for enabling a user to create one or more aliases, to link these one or more aliases to personal information, including financial and personal preference information, and to controllably reveal this information to selected other users on a per alias basis.

### BRIEF DESCRIPTION OF THE DRAWINGS

FIG. 1 depicts a conceptual diagram of an exemplary embodiment according to one aspect of the present invention.

FIG. 2 depicts another conceptual diagram of another exemplary embodiment according to another aspect of the present invention.

FIG. 3 depicts yet another conceptual diagram of still another exemplary embodiment according to another aspect of the present invention.

FIG. 4 depicts a block diagram of an apparatus for sharing files in a peer-to-peer environment according to another aspect of the present invention.

FIG. 5 depicts an exemplary embodiment of a method for managing identities according to yet another aspect of the present invention.

FIG. 6 depicts another exemplary embodiment of a method for managing identities according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

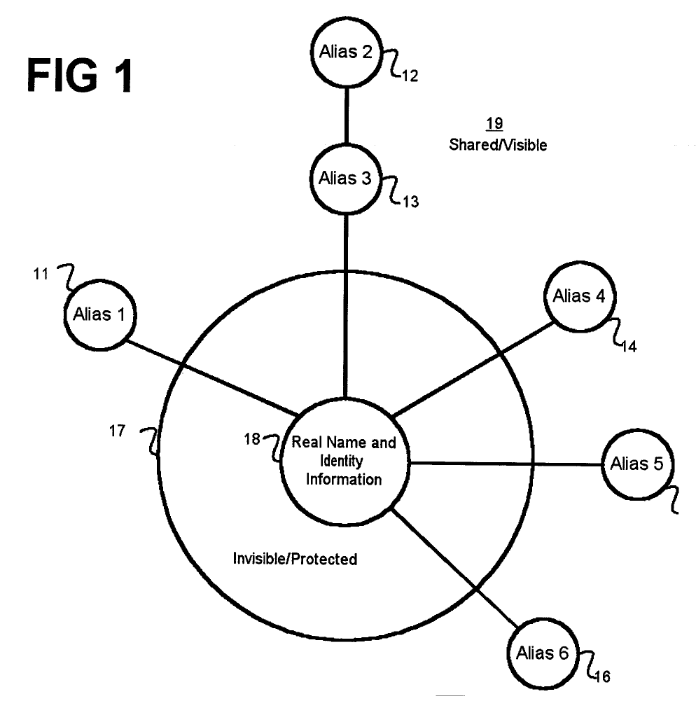

Turning to FIG. 1, shown therein is an exemplary scenario according to one aspect of the present invention, in which distributed/separate identities exist. Each alias 11-16 for a given person 18 is independent of the other aliases. The alias can be displayed more like an email, such as:

From: Aliasname

Subject: Content Attachment

Within the protected world 17 (e.g., a trusted server or network, the user's actual identity 18 is known in relation to the one or more aliases 11-16 the user may employ in the shared or unprotected space 19 (e.g., the peer-to-peer space). The actual identity 18 remains invisible to other users in this peer-to-peer space 19, and the protected space 17 is inaccessible or invisible to these other users. This allows the user 18 to conduct transactions with other users in the unprotected space 19 without revealing his actual identity 18.

According to one aspect of the present invention, a distributed peer-to-peer system or middleware layer supports the creation of multiple identities for use in peer-to-peer exchanges. A single peer can create as many aliases as he or she can see fit to use in content promotion. The peer might use one alias to promote jazz and another alias to promote rock music. Depending with whom the peer is interacting, the actual individual can choose to expose or unlock additional identities.

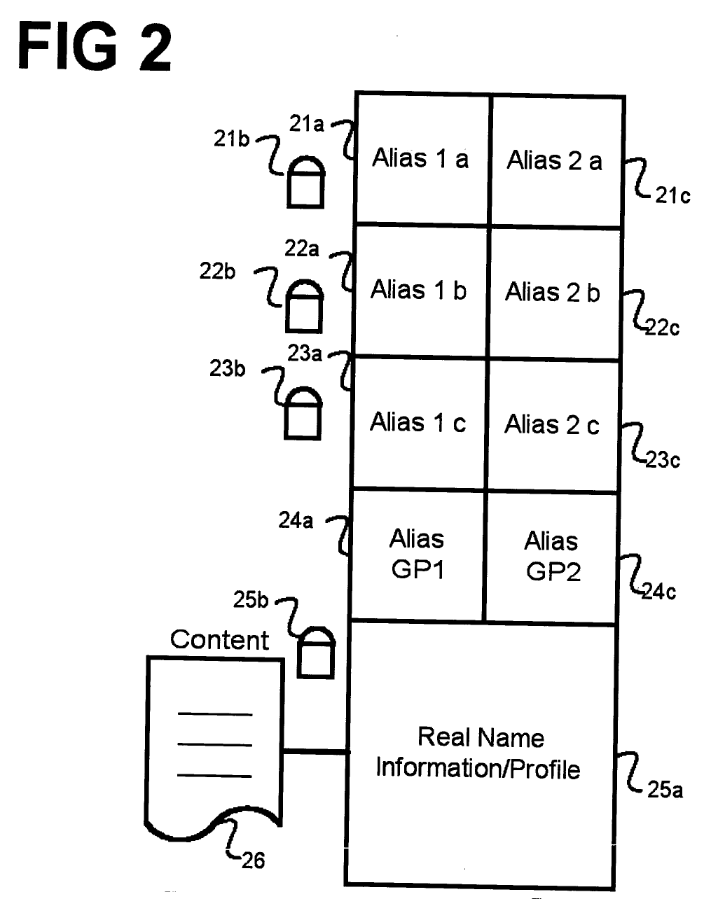

Turning to FIG. 2, shown therein is another exemplary scenario according to another aspect of the present invention, in which nested identities travel with the content. Each identity 21a-24a is shipped with the associated content 26; however, only one identity 24a remains visible. The identity owner 25a can unlock one or more aliases 24a or identities for trusted friends and associates 21c-24c. Thus, alias 24a is unlocked for trusted friend or associates 24c (i.e., no lock symbol, such as 21b-23b, is associated with this alias 24a). Each alias may contain more information about the owner, thereby enabling the owner to use one alias to disclose some information about himself and another alias to disclose more information about himself.

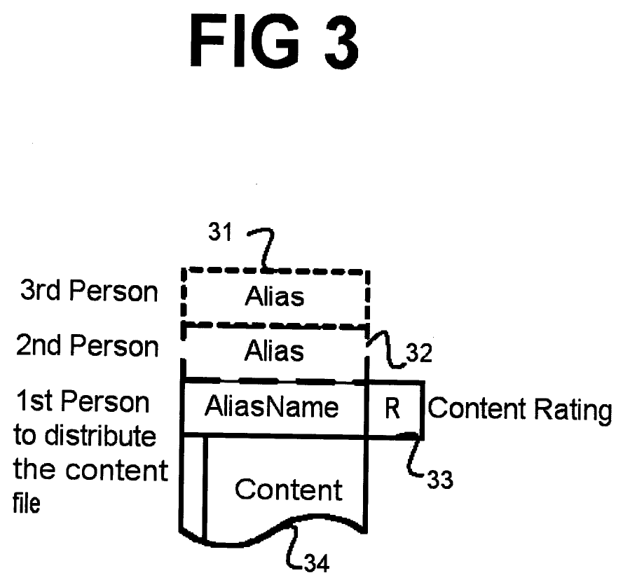

Turning to FIG. 3, shown therein is a third exemplary scenario according to yet another aspect of the present invention, in which a meta data file is attached to the content showing the distribution history and rating information. In this instance, each recipient 31, 32 of the content file 34 receives a history of who else sent the content and the rating 33 these people applied to the content 34.

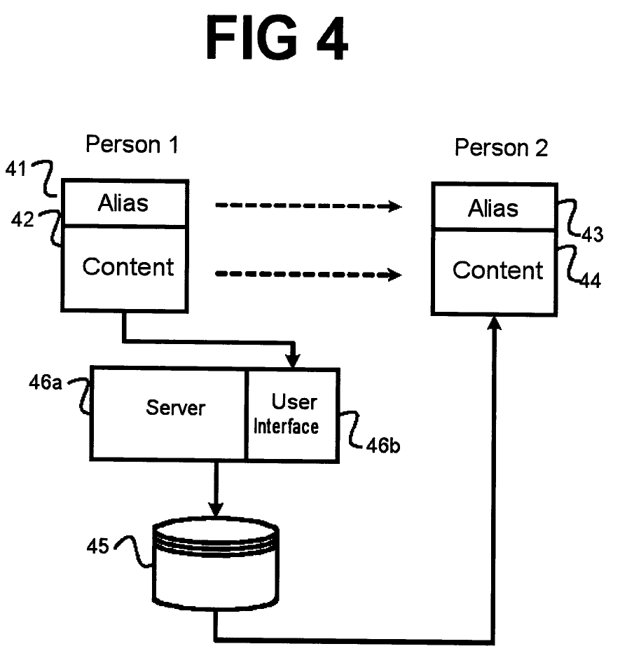

Turning to FIG. 4, shown therein is an exemplary embodiment of an apparatus for transferring content in a peer-to-peer environment according to yet another aspect of the present invention. In this apparatus, a third party trusted website (e.g., a server 46a, user interface 46b and/or a networked database 45) is used as a trusted directory of aliases/identifications. According to this method for supporting multiple aliases and associated actual identities, a third party organization 46a, 46b, 45 manages the aliases and actual identities. In this way, an individual can use as many aliases as desired while still being able to link financial transactions or commissions to a single actual name and account. For example, an individual could create an alias for use in file sharing of music, another alias for use in magazine subscriptions, and still another alias that provides complete anonymity. In this case, the third party actually performs the communications between the two users 41, 43, thereby ensuring complete anonymity among users while passing the desired content 42 along with user selected aliases and information about themselves.

Server 46a is a standard server capable of performing multiple communications simultaneously among different users. User interface 46b is a standard graphical user interface that prompts a user to enter information about himself and then stores this information in database 45. Database 45 is a standard database that permits storage and retrieval of information associated with an individual.

The above-described system can be used as a system of direct marketing. In this example, a user signs up for a service that allows him to register his real identity and then create one or more aliases associated (but hidden to others, or at least under control of the user) with this identity. The aliases, interest profile and generic identity descriptions are shared with third party companies looking to market products and services. The individual's identity remains hidden, providing the user protection against unwanted invasions of privacy. The user can also delete an alias if the user decides he or she no longer preferred the nature of the marketing they were receiving. For access to the user, the advertiser can pay both the user and the hosting service. The alias program provides the user the ability to protect and manage their Internet identities in new and more flexible ways.

According to one aspect of the present invention, an application or middleware layer is created that runs locally on any number of devices (e.g., a personal computer, a personal data apparatus (PDA), a networked music player, etc.). The application manages three areas:

1. The content (e.g., music, photos, etc.) to be shared.

2. The identity or alias that the user would like to associate with a set of common or peer-to-peer relationships; and

3. The establishment of connections and content exchange with other peers.

Content exchanges can either happen only with an alias name exchanged to another user with an alias and email address. The content being exchanged also includes either an explicit or implicit content rating from the source. As content is passed from peer to peer, a history is stored as meta-data associated with the actual content file. Over time, if a particular peer consistently recommends interesting content before other peers, then the particular peer will emerge as a kind of alpha (i.e., highest) recommender. In this case, recommendations from this alias will be perceived as stronger than those from other users and could grow in notoriety. Alternatively, a central service can be used to manage the recommendation history.

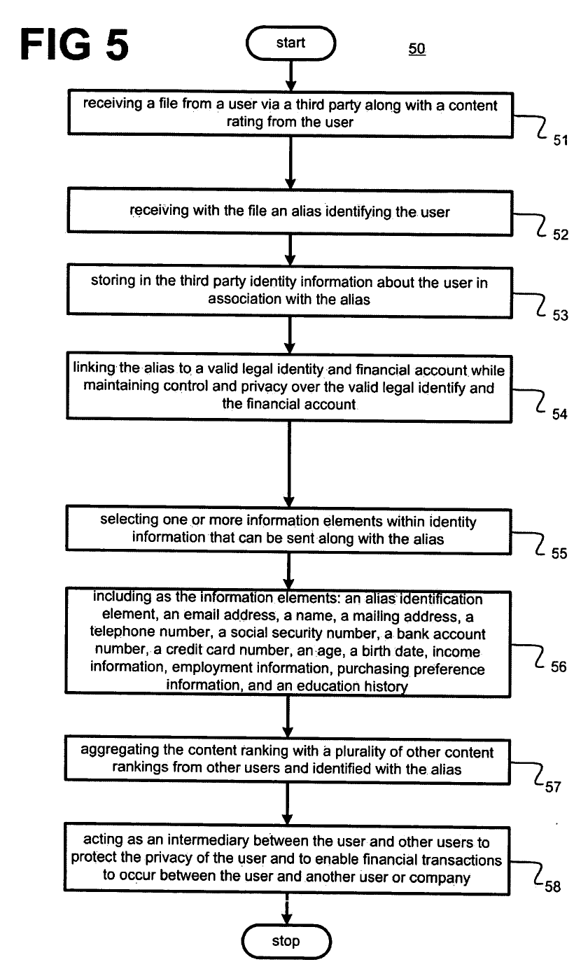

Turning to FIG. 5, shown therein is an exemplary embodiment of a method for performing a file transfer in a peer-to-peer environment according to another aspect of the present invention. According to this method 50, a file is received from a user via a third party along with a content rating from the user (element 51). Along with the file, an alias is received identifying the user (element 52). Identity information about the user is stored in the third party in association with the alias (element 53). The user can select one or more information elements within the identity information that can be sent along with the alias (element 54). Among that which can be included as the information elements are one or more of the following: an email address, a name, a mailing address, a telephone number, a social security number, a bank account number, a credit card number, an age, a birth date, income information, employment information, purchasing preference information, and an education history (element 55). Any single content rating is aggregated with other content rankings from other users and linked with the alias (element 56). The third party can then act as an intermediary between the user and other users to protect the privacy of the user and to enable financial transactions to occur between the user and another user or company (element 57). One or more of these elements 51-56 can be performed together to create various useful methods for transferring files and other information between users and others.

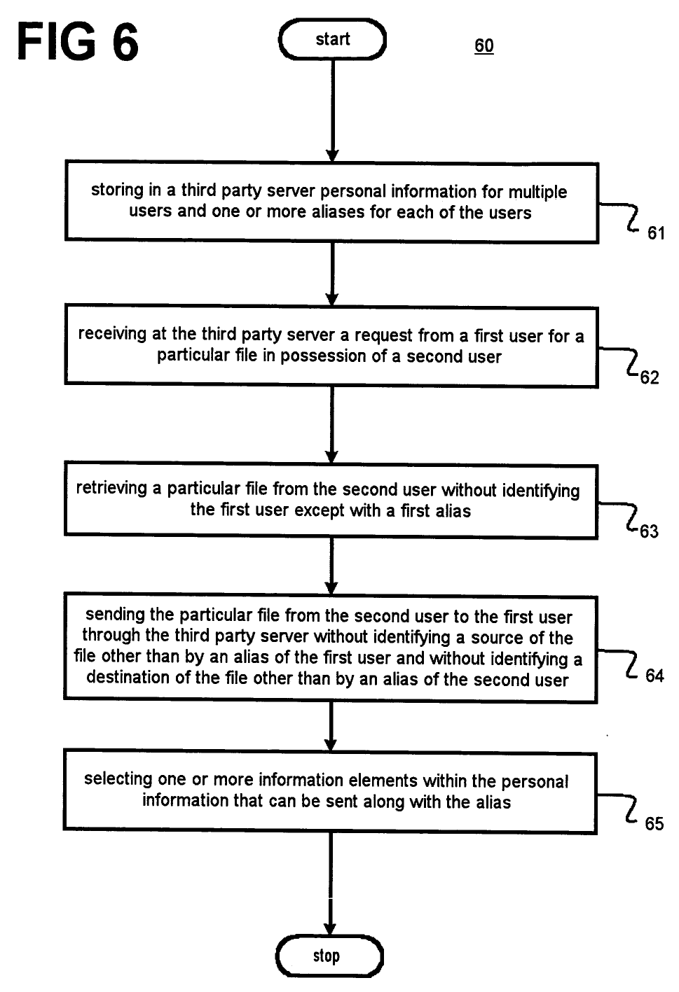

Turning to FIG. 6, shown therein is an exemplary embodiment of a method for performing a file transfer in a peer-to-peer environment according to another aspect of the present invention. According to this method 60, one or more aliases for each user is stored in a third party server along with personal information for each of the users (element 61). A request is received at the third party server from a first user for a particular file in possession of a second user (element 62). The particular file is then retrieved from the second user without identifying the first user except with a first alias (element 63). The particular file is thus sent from the second user to the first user through the third party server without identifying a source of the file other than by an alias of the first user and without identifying a destination of the file other than by an alias of the second user (element 64). As in the method 50 above, one or more information elements can be selected from among the personal information to be sent along with the alias (element 65). Moreover, one or more of these elements 61-65 can be performed together to create various useful methods for transferring files and other information between users and others.

According to the present invention, one exemplary embodiment of a user interface includes a list of information about the user that is ranked in relative level of sensitivity. A “window shade” icon then enables the user to increase or decrease the level of sensitive information that the user will disclose in association with the alias.

The above inventions and embodiments can be used in email systems to enable a third party to manage emails to and from users so that marketing emails can be sent to interested users or users who fit certain profiles without their identities being provided to these marketing companies. Moreover, limiting the emails to only certain users will greatly reduce the amount of junk mail for each user.

Although various embodiments are specifically illustrated and described herein, it will be appreciated that modifications and variations of the invention are covered by the above teachings and are within the purview of the appended claims without departing from the spirit and intended scope of the invention. For example, the present invention has been described in relation to a peer-to-peer environment, however, the same technique could be applied to other networking environment. Furthermore, this example should not be interpreted to limit the modifications and variations of the inventions covered by the claims but is merely illustrative of one possible variation.

What is claimed is:

1. A method for interacting with a user over a peer-to-peer network comprising:
receiving a file from a user via a third party;
receiving with the file an alias identifying the user; and
storing in the third party identity information about the user in association with the alias; and
linking the alias to a valid legal identity and financial account while maintaining control and privacy over the valid legal identify and the financial account.

2. The method according to claim 1, wherein the file is received along with a content rating from the user.

3. The method according to claim 1, wherein the user can select one or more information elements within identity information that can be sent along with the alias.

4. The method according to claim 2, wherein the one or more information elements include one or more of the following: an email address, a name, a mailing address, a telephone number, and a social security number.

5. The method according to claim 2, wherein the one or more information elements include one or more of the following: a bank account number, a credit card number, an age, a birth date, income information, employment information, purchasing preference information, and an education history.

6. The method according to claim 1, further comprising:
aggregating by the third party the content ranking with a plurality of other content rankings from other users and making this available to others without identification of the users or aliases.

7. The method according to claim 1, further comprising:
acting as an intermediary between the user and other users to protect the privacy of the user and to enable financial or marketing transactions to occur between the user and another user or company.

8. A method for protecting personal information in a peer-to-peer environment comprising:
storing in a third party server personal information for a plurality of users and one or more aliases for each of the plurality of users; and
sending a file from a first user of the plurality of users to a second user of the plurality of users through the third party server without identifying a source of the file other than by an alias of the first user and without identifying a destination of the file other than by an alias of the second user.

9. The method according to claim 8, wherein each of the plurality of users can select one or more information elements within the personal information that can be sent along with the alias.

10. The method according to claim 9, wherein the one or more information elements include one or more of the following: an email address, a name, a mailing address, a telephone number, and a social security number.

11. The method according to claim 9, wherein the one or more information elements include one or more of the following: a bank account number, a credit card number, an age, a birth date, income information, employment information, purchasing preference information, and an education history.

12. A method for transmitting files in a peer-to-peer environment comprising:
receiving at a third party server a request from a first user for a particular file in possession of a second user;
retrieving the particular file from the second user without identifying the first user except with a first alias; and
sending the particular file to the first user without identifying the second user expect with a second alias.

13. The method according to claim 12, further comprising:
storing in the third party server identity information for each of the first and second users along with one or more aliases for each of the first and second users.

14. The method according to claim 12, wherein each of the first and second users can select one or more information elements within the identity information that can be sent along with their alias.

15. The method according to claim 14, wherein the one or more information elements include one or more of the following: al alias identification element, an email address, a name, a mailing address, a telephone number, and a social security number.

16. The method according to claim 14, wherein the one or more information elements include one or more of the following: an alias identification element, a bank account number, a credit card number, an age, a birth date, income information, employment information, purchasing preference information, and an education history.

17. An apparatus for transmitting one or more files in a peer-to-peer environment, comprising:
a database storing identity information for at least two users along with one or more aliases for each of the at least two users; and
a server to receive requests for the one or more files from a destination user of the at least two users, to upload a requested file from a source user of the at least two users, and to transmit said requested file to the destination user along with an alias of the source user and to transmit an alias of the destination user to the source user.

18. The apparatus according to claim 17, further comprising a user interface via which each of the at least two users can create one or more aliases, enter personal identity information associated with each of the one or more aliases and selectively control whether one or more information elements within the personal identity information for each of the one or more aliases is transmitted along with the alias.

19. The apparatus according to claim 18, wherein the one or more information elements include one or more of the following: an alias identification element, an email address, a name, a mailing address, a telephone number, a social security number, a bank account number, a credit card number, an age, a birth date, income information, employment information, purchasing preference information, and an education history.

20. The apparatus according to claim 18, wherein the user interface further enables a user to provide a list of approved users to which the user can selectively reveal one or more information elements.
